(19) United States
(12) Patent Application Publication
(10) Pub. No.: US 2006/0075825 A1
(43) Pub. Date: Apr. 13, 2006

(54) Cassete for placing multiple-sized substrates

(76) Inventor: Kai-Yu Liu, Dajia Township (TW)

Correspondence Address: RABIN & Berdo, PC, 1101 14TH STREET, NW, SUITE 500, WASHINGTON, DC, 20005, US

(21) Appl. No.: 11/114,112

(22) Filed: Apr. 26, 2005

(30) Foreign Application Priority Data
Oct. 12, 2004 (TW) 93130907

(51) Int. Cl. G01N 3/00

(52) U.S. Cl. 73/788

(57) ABSTRACT

A cassette for placing multiple-sized substrates includes a first board, a second board, two sidewalls, a number of dividers and an adjustable positioning device. The first board, the second board and the two sidewalls form a space. The dividers divide the space into several substrate-receiving spaces for placing substrates. The adjustable positioning device which movably connected to the first board and the second board is used to adjust the width of the substrate-receiving spaces.

This application claims the benefit of Taiwan application Serial No. 93130907, filed Oct. 12, 2004, the subject matter of which is incorporated herein by reference.

### BACKGROUND OF THE INVENTION

1. Field of the Invention

The invention relates in general to a cassette for placing substrates, and more particularly to a cassette for placing multiple-sized substrates.

2. Description of the Related Art

Glass substrates are the crucial elements for producing the liquid crystal displays. Due to multiple specifications of the liquid crystal displays, different sizes glass substrates are needed. Thus, to provide a cassette for placing multiple-sized substrates is necessary. Concerning the cost and the space, an adjustable cassette for placing multiple-sized substrates is a good option in practical use. By means of the adjustable cassette, these multiple-sized glass substrates could be positioned respectively according to the sizes.

Referring to FIG. 1, a frontal view of a typical cassette for placing multiple-sized substrates is shown. The cassette 101 includes a first board 102, a second board 103, a number of dividers 120 and two sidewalls 105. The first board 102, the second board 103 and the two sidewalls 105 form a space 130. As shown in FIG. 1, the dividers 120 which separate the space 130 into several substrate-receiving spaces 150 are disposed inside of the two sidewalls 120.

A number of concaves 106 of the first board 102 located on the junction of the first board 102 and the sidewall 105, and a number concaves 107 of the second board 103 are located on the junction between the second board 103 and the sidewall 105. The two sidewalls 105 could be moved back and forth in the concaves 106 and the concaves 107. The top end and the bottom end of the two sidewalls 105 are fastened via the screws 108 of the first board 102 and the screws 109 of the second board 103. Meanwhile, in order to place multiple-sized substrates, the width of the substrate-receiving spaces 150 could be adjusted via controlling the movement of the two sidewalls 105 in the concaves 106 and the concaves 107.

To place multiple-sized substrates, the screws 109 of the first board 102 and the screws 109 of the second board 103 should be loosened first. Hence, one can adjust the two sidewalls 105 in the concaves 106-107 according to the sizes of the substrates. At last, to tighten the screws 108 and 109, the two sidewalls 105 are then fastened to place different sizes substrates. As illustrated above, the more the sizes of the substrates are provided, the more number of the times one should to disassemble and to reassemble the two sidewalls. It is both a time-consuming and a laborious method to position the two sidewalls. In addition, in order to disassemble and to reassemble the two sidewalls, the tools, for instance the screw driver, should be prepared in the very beginning.

### SUMMARY OF THE INVENTION

It is therefore an object of the invention to provide a cassette for placing multiple-sized substrates. Without any tool to facilitate, one can adjust the width of the substrate containing chamber to place multiple-sized substrates.

The invention achieves the above-identified object by providing a cassette. A cassette for placing multiple-sized substrates includes a first board, a second board, two sidewalls, a number of dividers and an adjustable positioning device. The first board, the second board and the two sidewalls form a space. The dividers divide the space into several substrate-receiving spaces for placing substrates. The adjustable positioning device which movably connected to the first board and the second board is used to adjust the width of the substrate-receiving spaces.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a frontal view of a typical cassette for placing multiple-sized substrates.

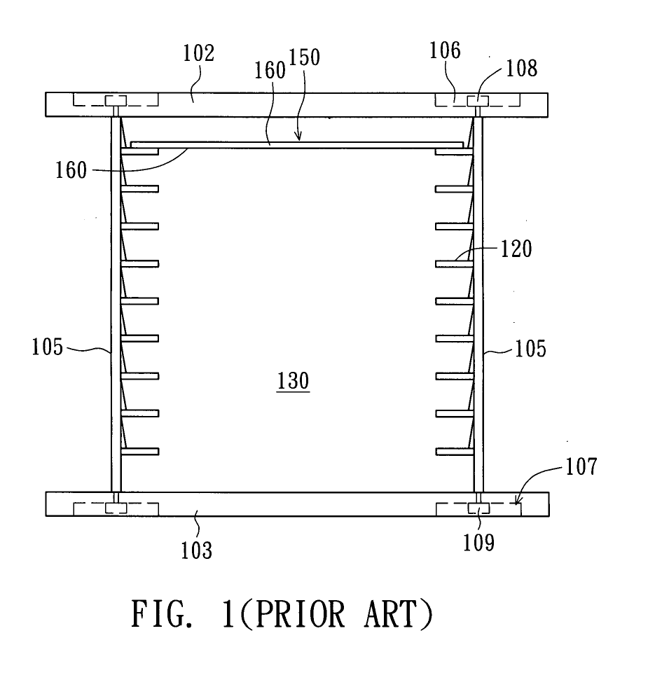

FIG. 2 is a frontal view of a cassette for placing cassettes according to a preferred embodiment of the invention.

FIG. 3 is a top view of the cassette in FIG. 2.

FIG. 4A is a perspective view of the adjustable positioning device in the preferred embodiment.

FIG. 4B is a perspective view of the positioning member in FIG. 4A.

FIG. 4C is a perspective view of another positioning member in FIG. 4A.

### DETAILED DESCRIPTION OF THE INVENTION

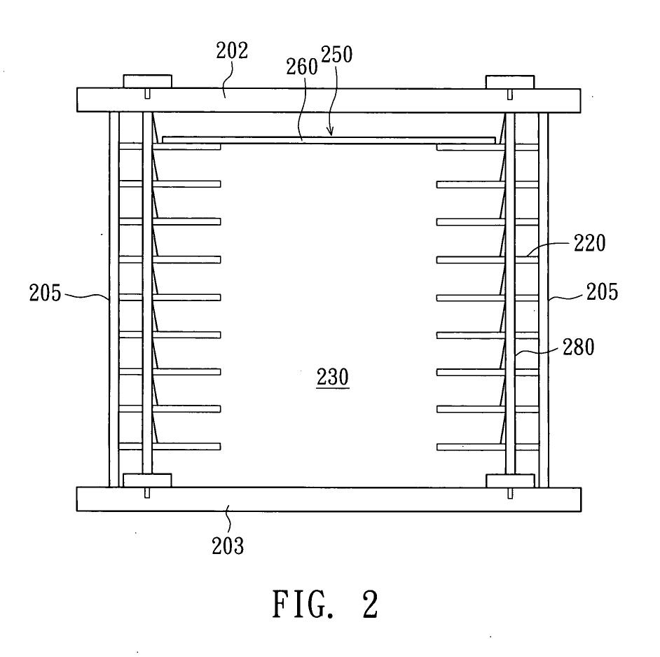

Referring to FIG. 2, a frontal view of a cassette for placing cassettes according to a preferred embodiment of the invention is shown. The cassette has a first board 202, a second board 203, two sidewalls 205, a number of dividers 220 and an adjustable positioning device 209. The first board 202 is disposed parallel to the second board 203, the two sidewalls 205 are both perpendicularly connected to the first board 202 and the second board 203. The first board 202, the second board 203 and the two sidewalls 205 form a space 230. The dividers 220 are disposed on the two sidewalls 205 to divide the space 230 into several substrate-receiving spaces 250. The adjustable positioning device 209 has a positioning member 280, which the positioning member 280 is movably connected to the first board 202 and the second board 203. The adjustable positioning device 209 being integrated on the sidewalls 205 is used for adjusting the width of these substrate-receiving spaces 250.

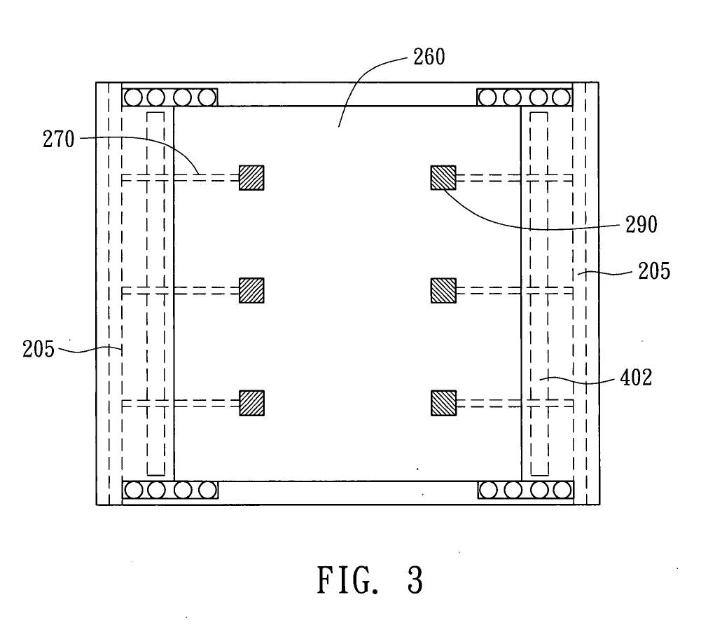

Referring to FIG. 2 and FIG. 3, FIG. 3 is a top view of the cassette in FIG. 2. The dividers 220 protrude and extend inside from the two sidewalls 205. As shown in FIG. 3, the dividers 220 preferably comprise several supporting bars 270. These supporting bars 270 further include a number of anti-slippery pads 290 on the ends of the supporting bars 270. The anti-slippery pads 290 are high frictional materials to prevent the substrates 260 sliding on the anti-slippery pads 290. In addition, to increase the sizes of the supporting bars 270 could be carried, these supporting bars 270 are elongated made. Furthermore, the dividers 220 may be any kind of structure that can support the substrates 260 including supporting bars and supporting boards. Additionally, the anti-slippery pads 290 can be placed on the surface of the dividers 220.

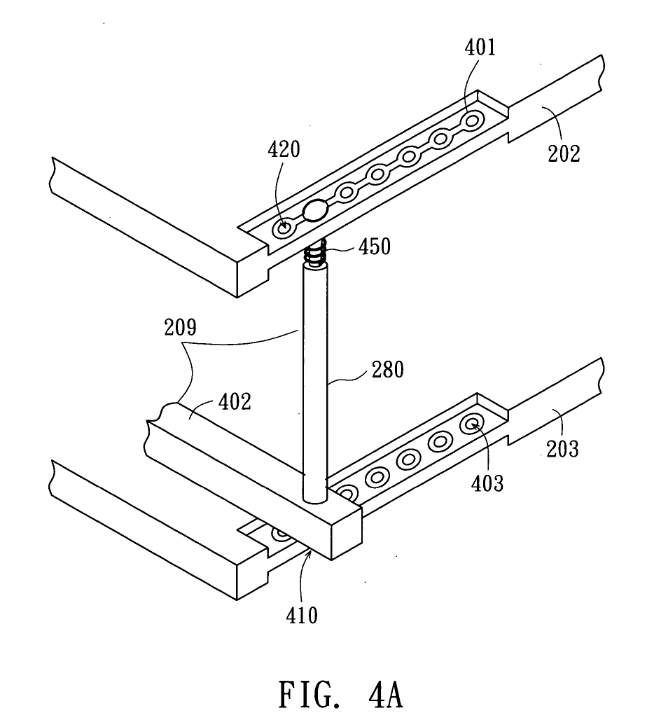

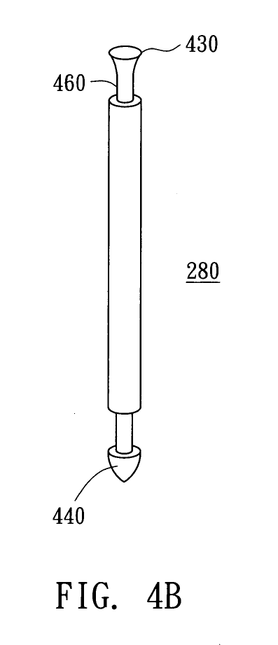

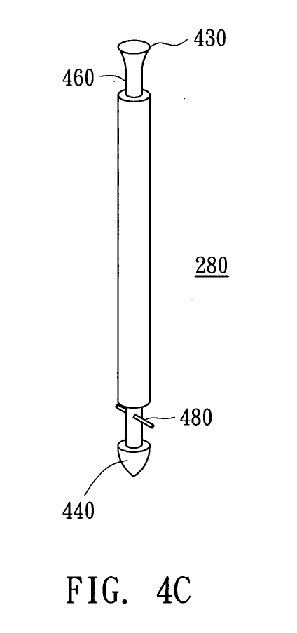

Referring to FIG. 4A and FIG. 4B, FIG. 4A is a perspective view of the adjustable positioning device in the preferred embodiment and FIG. 4B is a perspective view of the positioning member in FIG. 4A. The adjustable positioning device includes a positioning member 280, several positioning holes such as the lower positioning holes 403, track 401, spring 450 and the positioning structure 402. The positioning structure 402 is able to be a positioning bar or a positioning board perpendicularly connecting to the adjustable positioning device 209. The track 401 is established on the first board 202, and the lower positioning holes 403 are formed on the second board 203. The positioning structure 402 connected to the positioning members 280 is used for maintaining the width of the substrate-receiving spaces 250 as shown in FIG. 2. In FIG. 4A, the track 401 is a chained shape track which is formed from a successive upper positioning holes 420. The upper positioning holes 420 opposite to the lower positioning holes 403 are located on the second board 203. The spring 450 which makes the positioning member 280 moves back and forth on the track 401 is located around the neck of the positioning member 280. As shown in FIG. 4B, an inserting portion 440 disposed on the bottom of the positioning member 280 is used for inserting one of the lower positioning holes 403 switchably. Moreover, the positioning member 280, which is used for fastening one of these upper positioning holes 420 has a fastening portion 430 adjacent to the sliding portion 460.

To adjust the width of the containing spaces 250, first of all, is to apply a force on the positioning member 280. By compressing the spring 450, the positioning member 280 moves upward relatively to the first board 202 and the second board 203. Meanwhile, the inserting portion 430 moves away from one of the upper positioning holes 420 in temporary. Therefore, the sliding portion 460 may slides on the track 401. When the positioning member 280 moves to a specific position 410, either the restoring force from the spring 450 or applying a downward force on the positioning member 280, the positioning member 280 moves downward relatively to the first board 202 and to the second board 203. Thus, the inserting portion 440 is inserted in one of the lower positioning holes 403 and the fastening portion 430 is fastened in one of these upper positioning holes 420.

Referring to FIG. 4C, a perspective view of another positioning member in FIG. 4A is shown. In order to moves the positioning member 280 more easily, the positioning member 280 may further comprises a pin 480, which makes the inserting portion 440 able to be fixed on a higher position relatively to the second board 203.

According to the disclosure of the above embodiments, workers can easily adjust the width of the cassette by the adjustable positioning device without any tools to facilitate. In a short time, the width can be adjusted, and then be maintained by the positioning bar. Therefore, the cassette disclosed in the above embodiments would be a time-saving and energy-saving cassette for the workers.

What is claimed is:

1. A cassette for placing multiple-sized substrates, comprising:
a first board;
a second board, disposed parallel to the first board;
two sidewalls, both perpendicularly connected to the first board and the second board, wherein the first board, the second board and the two sidewalls form a space;
a plurality of dividers, disposed on the two sidewalls, wherein the dividers divide the space into a plurality of substrate-receiving spaces; and
an adjustable positioning device, movably connected to the first board and the second board, wherein the adjustable positioning device is used to adjust the width of the substrate-receiving spaces.

2. The cassette according to claim 1, wherein the adjustable positioning device comprises a positioning structure perpendicularly connected to the adjustable positioning device.

3. The cassette according to claim 2, wherein the positioning structure is a positioning bar.

4. The cassette according to claim 2 wherein the positioning structure is a positioning board.

5. The cassette according to claim 1, wherein the adjustable positioning device is integrated to the sidewalls.

6. The cassette according to claim 1, further comprising:
a track, located on the first board; and
a plurality of positioning holes, located on the second board.

7. The cassette according to claim 6, wherein the track is a plurality of successive positioning holes.

8. The cassette according to claim 6, wherein the adjustable positioning device comprises:
an inserting portion, located on one end of the adjustable positioning device; and
a sliding portion, located on the other end of the adjustable positioning device.

9. The cassette according to claim 8, wherein the adjustable positioning device further comprises an elastic member.

10. The cassette according to claim 8, wherein the adjustable positioning device further comprises a pin.

11. The cassette according to claim 1, wherein the dividers comprise a plurality of supporting bars.

12. The cassette according to claim 1, wherein the dividers comprise a plurality of supporting boards.

13. The cassette according to claim 1, wherein the dividers comprise a plurality of anti-slippery pads.

14. The cassette according to claim 13, wherein the anti-slippery pads comprise high frictional materials.

15. The cassette according to claim 13, wherein the anti-slippery pads are disposed on the ends of the dividers.
